(19) United States
(12) Patent Application Publication
(10) Pub. No.: US 2024/0188505 A1
(43) Pub. Date: Jun. 13, 2024

(54) PLANTING METHOD FOR CEREAL CROPS IN PLANT FACTORY TO PROMOTE FOUR TO FIVE CROPS PER YEAR

(71) Applicant: FUJIAN SANAN SINO-SCIENCE PHOTOBIOTECH CO., LTD., Quanzhou (CN)

(72) Inventors: Yang LI, Quanzhou (CN); Tingting WANG, Quanzhou (CN)

(21) Appl. No.: 18/266,276

(22) PCT Filed: Jul. 19, 2021
(86) PCT No.: PCT/CN2021/107140

§ 371 Date: Dec. 26, 2023

(51) Int. Cl. A01G 7/04; A01G 22/20

(52) U.S. Cl. CPC A01G 7/045; A01G 22/20

(57) ABSTRACT

The present invention discloses a planting method for cereal crops in a plant factory to promote four to five crops per year. During the planting period, the cereal crops are cultivated under the irradiation of blue-yellow-red-far red mixed light. In the blue-yellow-red-far red mixed light, the photon ratio of red light (600-699 nm) and blue light (400-499 nm) is 3-4, the photon ratio of red light (600-699 nm) and yellow light (500-599 nm) is 3-7, and the photon ratio of red light (600-699 nm) and far-red (FR) light (700-780 nm) is 3-4. The present invention ensures the normal growth of cereal crops under the control of artificial light planting environment, realizes four to five crops per year of cereal crops, greatly shortens the crop planting cycle, and improves the utilization rate of land and water resources.

### TECHNICAL FIELD

The present invention belongs to the technical field of agricultural planting, and particularly relates to a planting method for cereal crops in a plant factory to promote four to five crops per year.

### BACKGROUND

China is one of the largest developing countries in the world, and its special national conditions determine that agriculture plays a far more important role in China than in other countries in the world. Agricultural industry is composed of agriculture, forestry, animal husbandry, and fishery. Agriculture is composed of field crops and horticultural crops, and field crops can be divided into grain crops, cash crops, and fodder and green manure crops, of which food crops are the most important because they serve as a basis for the survival and development of human beings. Cereal crops refer to gramineous crops that are cultivated to harvest grains and are the main components of grain crops in China. According to morphological characteristics, cereal crops can be divided into wheat crops including wheat, barley, oat, etc. and millet crops including rice, corn, sorghum, millet, etc. Cereals are the most important source of heat energy for the human body. About 80% of the heat energy required by the human body and about 50% of the proteins required by the human body are provided by cereals. In 2019, cereal sown area was 1.468 billion mu in China, decreasing by 27.36 million mu compared with 2018. Rice accounted for 445 million mu, wheat accounted for 356 million mu, and corn accounted for 619 million mu.

At present, there are still many problems existing in the development of grain crops in China, which is mainly manifested in the following aspects:

(1) Land resources, especially arable land resources, are constantly decreasing. Currently, arable land area is only 1.2 mu per capita in China and accounts for 32% of arable land area per capita worldwide. (2) The quality of arable lands deteriorates. In China, water and soil loss area is large, desertification land is gradually increasing, and saline-alkali land is extensively distributed. (3) The production cost of agricultural products is continuously rising, while the income is constantly declining. (4) Resources and production technology are limited. The current agricultural technology in China is still quite backward overall, the level of mechanization in most regions is low, and the productivity is not high. (5) The lack of water resources and serious pollution problems have become the main factors restricting agricultural development.

Therefore, there is an urgent need for a planting method that can solve the problems of insufficient arable land resources, decreased quality of arable lands, saving water resources, and increasing food production.

### SUMMARY

In view of the above, the objective of the present invention is to provide a planting method for cereal crops in a plant factory to promote four to five crops per year. In the present invention, cereal crops are planted indoors under the control of artificial light planting environment, which realizes four to five crops per year of rice, corn, and wheat, greatly shortens the crop planting cycle, and improves the utilization rate of land and water resources.

The specific technical solutions of the present invention are as follows:

A planting method for cereal crops in a plant factory to promote four to five crops per year is provided. During the whole planting period, the cereal crops are cultivated under the irradiation of blue-yellow-red-far red mixed light.

In the blue-yellow-red-far red mixed light, the photon ratio of red light (600-699 nm) and blue light (400-499 nm) is 3-4, the photon ratio of red light (600-699 nm) and yellow light (500-599 nm) is 3-7, and the photon ratio of red light (600-699 nm) and far-red (FR) light (700-780 nm) is 3-4.

Preferably, during seedling cultivation period, the photoperiod is 12 h/d, and the light intensity is 200-300 μmol/m²·s; during the cultivation period after planting, the photoperiod is 12-18 h/d, and the light intensity is 400-600 μmol/m²·s.

More preferably, the planting method includes the following steps:
(1) sowing: putting a composite cultivation substrate in a seedling cultivation tray, sowing vernalized or germinated cereal seeds with one to two seeds per hole at a depth of 1 cm, covering with soils, thoroughly soaking the substrate with clear water, covering with plastic wraps, and removing the plastic wraps after germination;
(2) seedling cultivation: placing the seedling cultivation tray with the removal of the plastic wraps under the blue-yellow-red-far red mixed light, where the light environment conditions during the seedling cultivation period include: the photoperiod of 12 h/d, and the light intensity of 200-300 μmol/m²·s, keeping the substrate moist during the seedling cultivation process;
(3) cultivation: when the seedlings grow to 13-18 cm, transplanting the seedlings to a specific planting module, and cultivating under the blue-yellow-red-far red mixed light until harvesting, where the light environment conditions include: the photoperiod of 12-18 h/d, and the light intensity of 400-600 μmol/m²·s.

Preferably, during the cultivation period, the light environment can be changed correspondingly according to the different growth and development stages of different crops, the photoperiod is controlled within the range of 12-18 h/d, and the light intensity is controlled within the range of 400-600 μmol/m²·s.

Preferably, during the seedling cultivation period, the ambient temperature is 23-28° C. during the day and 18-20° C. at night.

Preferably, during the cultivation period, the ambient temperature is 23-28° C. during the day and 19-21° C. at night.

Preferably, the water and fertilizer management method during the cultivation period includes: regularly applying a compound fertilizer, and controlling the moisture in the substrate by watering only when it is dry.

The advantages of the present invention are as follows: The present invention ensures the normal growth of cereal crops under the control of artificial light planting environment, realizes four to five crops per year of cereal crops, greatly shortens the crop planting cycle, and improves the utilization rate of land and water resources.

### DETAILED DESCRIPTION OF THE EMBODIMENTS

The present invention will be further described in detail below in conjunction with the embodiments, but the embodiments of the present invention are not limited thereto. Without departing from the technical concepts of the present invention described above, various replacements and changes can be made according to common technical knowledge and conventional means in the art, which should be included within the scope of the present invention.

The embodiment of the present invention provides a planting method for cereal crops in a plant factory to promote four to five crops per year. The main technical conditions include light environment control technology and indoor water and fertilizer management technology.

### Planting Process:

(1) vernalization: soaking wheat seeds in clear water for 3-5 h, taking out and wrapping with gauze, and putting in a 4° C. refrigerator for a low-temperature treatment for 13-16 d;
(2) germination: wrapping rice and corn with gauze, soaking in clear water for germination at 30° C.-35° C., and replacing the clear water once a day during germination;
(3) sowing: putting a composite substrate in a 32-hole seedling cultivation tray, sowing vernalized or germinated seeds with one to two seeds per hole at a depth of about 1 cm, covering with soils, thoroughly soaking the substrate with clear water, covering with plastic wraps, and removing the plastic wraps after germination;
(4) seedling cultivation: placing the seedling cultivation tray with the removal of the plastic wraps under a specific light environment, where the ambient temperature is 23-28° C. during the day and 18-20° C. at night, the early photoperiod is 12 h/d, and the light intensity is 200-300 μmol/m²·s, keeping the substrate moist during the seedling cultivation process;
(5) cultivation: when the seedlings grow to 13-18 cm, transplanting the seedlings to a specific planting module, where during the planting, the ambient temperature is 23-28° C. during the day and 19-21° C. at night, the photoperiod is 12-18 h/d, and the light intensity is 400-600 μmol/m²·s, changing the light environment correspondingly according to the different growth and development stages of different crops, applying a compound fertilizer regularly, and controlling the moisture in the substrate by watering only when it is dry, where the light formulation during the planting is controlled as: the photon ratio of red light (600-699 nm) and blue light (400-499 nm) is 3-4, the photon ratio of red light (600-699 nm) and yellow light (500-599 nm) is 3-7, and the photon ratio of red light (600-699 nm) and far-red (FR) light (700-780 nm) is 3-4;
(6) harvesting: harvesting after the crops are mature, calculating the planting cycle, and weighing the 100-grain weight.

### Embodiment 1

Vernalized wheat seeds are sown into a 32-hole seedling cultivation tray filled with sterilized substrate with two seeds per hole. The substrate is composed of 30% vermiculite and 70% peat soil. The sowing depth is about 1 cm, soil covering is performed, and the seedling cultivation substrate is thoroughly soaked with clear water. After the seeds germinate, the seedling cultivation tray is placed in a specific seedling cultivation environment, where the ambient temperature is 23-25° C. during the day and 19° C. at night, the early photoperiod is 12 h/d, and the light intensity is 200-300 μmol/m²·s. During the seedling cultivation process, the seedling cultivation substrate is kept moist, and the compound fertilizer is applied every 7 d. When the seedlings grow to 13-15 cm, they are transplanted to a specific planting module, and the cultivation substrate is composed of 30 vol % vermiculite, 60 vol % peat soil, and 10 vol % humus. The planting ambient temperature is 25-28° C. during the day and 19-21° C. at night, the photoperiod at the early cultivation stage is 12 h/d, the photoperiod at the filling stage and the early milk ripening stage is 18 h/d, the light intensity is 400-600 μmol/m²·s, and the photoperiod at the late milk ripening stage is 11 h/d, the light intensity is 300-400 μmol/m²·s. The compound fertilizer is regularly applied throughout the cultivation period. During the planting process, the cultivation substrate is watered only when it is dry. The wheat is harvested after it is mature, the planting cycle is calculated, and the 100-grain weight is weighed. The results are shown in Table 1 below:

TABLE 1

| | | Spectral composition and peak characteristics | | | Biological indicators | |
|---|---|---|---|---|---|---|
| | | Photon ratio | Photon ratio | Photon ratio | | 1000- |
| | | of 600-699 | of 600-699 | of 600-699 | | grain |
| | Type of | nm to 400- | nm to500-599 | nm to 700- | Planting | weight |
| No | light | 499 | nm | 780 nm | cycle (d) | (g) |
| Embodiment 1 | Neon light | 11.4 | 0.8 | 7.2 | 85 | 2.41 |
| Embodiment 2 | LED light 1 | 3.1 | 5.0 | 3.5 | 85 | 3.07 |
| Embodiment 3 | LED light 2 | 3.7 | 3.3 | 3.0 | 85 | 3.21 |
| Embodiment 4 | LED light 3 | 3.9 | 6.8 | 3.3 | 85 | 3.36 |
| Embodiment 5 | LED light 4 | 3.8 | 2.8 | 3.0 | 85 | 2.94 |
| Embodiment 6 | LED light 5 | 3.8 | 2.5 | 2.7 | 85 | 2.68 |

It can be seen from the results of Embodiment 1 that the 100-grain weight of wheat treated by LED2 and LED3 is relatively large.

### Embodiment 2

Germinated rice seeds are sown into a 32-hole seedling cultivation tray filled with sterilized substrate with two seeds per hole. The seedling cultivation substrate is composed of 30 vol % vermiculite and 70% peat soil. The sowing depth is about 1 cm, soil covering is performed, and the seedling cultivation substrate is thoroughly soaked with clear water. After the seeds germinate, the seedling cultivation tray is placed in a specific seedling cultivation environment, where the ambient temperature is 25-27° C. during the day and 20° C. at night, the early photoperiod is 12 h/d, and the light intensity is 200-250 μmol/m²·s. During the seedling cultivation process, the seedling cultivation substrate is kept moist, and the compound fertilizer is applied every 7 d. When the seedlings grow to 13-15 cm, they are transplanted to a specific planting module, and the cultivation substrate is composed of 30 vol % vermiculite, 50 vol % peat soil, and 20 vol % rice soil. The planting ambient temperature is 23-28° C. during the day. The temperature during the flowering and filling stage is 25-28° C. during the day and 21° C. at night, the photoperiod is 12-14 h/d, the light intensity is 350-500 μmol/m²·s, and the light intensity at the late milk ripening stage is 300-400 μmol/m²·s. The compound fertilizer is regularly applied throughout the cultivation period. During the planting process, the cultivation substrate must be kept moist. The rice is harvested after it is mature, the planting cycle is calculated, and the 100-grain weight is weighed.

TABLE 2

| | | Spectral composition and peak characteristics | | | Biological indicators | |
|---|---|---|---|---|---|---|
| | | Photon ratio | Photon ratio | Photon ratio | | 100- |
| | | of 600-699 | of 600-699 | of 600-699 | | grain |
| | Type of | nm to 400- | nm to500-599 | nm to 700- | Planting | weight |
| No | light | 499 | nm | 780 nm | cycle (d) | (g) |
| Embodiment 1 | Neon light | 11.4 | 0.8 | 7.2 | 90 | 1.85 |
| Embodiment 2 | LED light 1 | 3.1 | 5.0 | 3.5 | 90 | 2.04 |
| Embodiment 3 | LED light 2 | 3.7 | 3.3 | 3 | 90 | 2.25 |
| Embodiment 4 | LED light 3 | 3.9 | 6.8 | 3.3 | 90 | 2.33 |
| Embodiment 5 | LED light 4 | 3.8 | 2.8 | 3.0 | 90 | 2.18 |
| Embodiment 6 | LED light 5 | 3.8 | 2.5 | 2.7 | 90 | 2.93 |

It can be seen from the results of Embodiment 2 that the 100-grain weight of rice treated by LED2 and LED3 is relatively large.

### Embodiment 3

Germinated corn seeds are sown into a 32-hole seedling cultivation tray filled with sterilized substrate with one seed per hole. The seedling cultivation substrate is composed of 30 vol % vermiculite and 70% peat soil. The sowing depth is about 1 cm, soil covering is performed, and the seedling cultivation substrate is thoroughly soaked with clear water. After the seeds germinate, the seedling cultivation tray is placed in a specific seedling cultivation environment, where the ambient temperature is 23-25° C. during the day and 20° C. at night, the early photoperiod is 12 h/d, and the light intensity is 200-250 μmol/m²·s. During the seedling cultivation process, the seedling cultivation substrate is kept moist, and the compound fertilizer is applied every 7 d. When the seedlings grow to 10-10 cm, they are transplanted to a specific planting module, and the cultivation substrate is composed of 20 vol % vermiculite, 50 vol % peat soil, and 20 vol % yellow soil. The planting ambient temperature is 25-28° C. during the day and 20° C. at night. At the early planting stage, the photoperiod is 12-16 h/d, the light intensity at the top of plants is 350-500 μmol/m²·s, and the light is supplemented at the side of plants for 6-8 h/d at the light intensity of 80 μmol/m²·s. At the later mature stage, the photoperiod is 10-12 h/d, the light intensity at the top of plants is 350 μmol/m²·s, and the side of plants is not supplemented with light. The compound fertilizer is regularly applied throughout the cultivation period. During the planting process, the cultivation substrate is only watered when it is dry. The corn is harvested after it is mature, the planting cycle is calculated, and the 100-grain weight is weighed.

TABLE 3

| | | Spectral composition and peak characteristics | | | Biological indicators | |
|---|---|---|---|---|---|---|
| | | Photon ratio | Photon ratio | Photon ratio | | 100- |
| | | of 600-699 | of 600-699 | of 600-699 | | grain |
| | Type of | nm to 400- | nm to500-599 | nm to 700- | Planting | weight |
| No | light | 499 | nm | 780 nm | cycle (d) | (g) |
| Embodiment 1 | Neon light | 11.4 | 0.8 | 7.2 | 80 | 30.94 |
| Embodiment 2 | LED light 1 | 3.1 | 5.0 | 3.5 | 80 | 34.94 |
| Embodiment 3 | LED light 2 | 3.7 | 3.3 | 3 | 80 | 37.98 |
| Embodiment 4 | LED light 3 | 3.9 | 6.8 | 3.3 | 80 | 39.04 |
| Embodiment 5 | LED light 4 | 3.8 | 2.8 | 3.0 | 80 | 32.04 |
| Embodiment 6 | LED light 5 | 3.8 | 2.5 | 2.7 | 80 | 29.34 |

It can be seen from the results of Embodiment 3 that the 100-grain weight of corn treated by LED1-LED3 is relatively large.

The results of Embodiments 1-3 show that under the light environment of the present invention, the planting cycle is 80-90 d. Therefore, cereal crops planted by the planting method of the present invention achieve four to five crops per year, greatly shortening the crop planting cycle and improving the utilization rate of land and water resources.

Although the above-mentioned embodiments have been described, those skilled in the art can make additional changes and modifications to these embodiments once they know the basic creative concept. Therefore, the above is only the embodiments of the present invention and is not intended to limit the scope of patent protection of the present invention. Any equivalent structure or equivalent process transformation made by using the specification and drawings of the present invention, or directly or indirectly used in other related technical fields, is also included within the scope of patent protection of the present invention.

What is claimed is:

1. A planting method for cereal crops in a plant factory to promote four to five crops per year, comprising cultivating the cereal crops under the irradiation of blue-yellow-red-far red mixed light during the whole planting period, wherein
in the blue-yellow-red-far red mixed light, the photon ratio of red light (600-699 nm) and blue light (400-499 nm) is 3-4, the photon ratio of red light (600-699 nm) and yellow light (500-599 nm) is 3-7, and the photon ratio of red light (600-699 nm) and far-red (FR) light (700-780 nm) is 3-4.

2. The planting method for cereal crops in a plant factory to promote four to five crops per year according to claim 1, wherein during seedling cultivation period, the photoperiod is 12 h/d, and the light intensity is 200-300 μmol/m²·s; and during the cultivation period after planting, the photoperiod is 12-18 h/d, and the light intensity is 400-600 μmol/m²·s.

3. The planting method for cereal crops in a plant factory to promote four to five crops per year according to claim 1, comprising the following steps:
(1) sowing: putting a composite cultivation substrate in a seedling cultivation tray, sowing vernalized or germinated cereal seeds with one to two seeds per hole at a depth of 1 cm, covering with soils, thoroughly soaking the substrate with clear water, covering with plastic wraps, and removing the plastic wraps after germination;
(2) seedling cultivation: placing the seedling cultivation tray with the removal of the plastic wraps under the blue-yellow-red-far red mixed light, wherein the light environment conditions during the seedling cultivation period include: the photoperiod of 12 h/d, and the light intensity of 200-300 μmol/m²·s, keeping the substrate moist during the seedling cultivation process;
(3) cultivation: when the seedlings grow to 13-18 cm, transplanting the seedlings to a specific planting module, and cultivating under the blue-yellow-red-far red mixed light until harvesting, wherein the light environment conditions include: the photoperiod of 12-18 h/d, and the light intensity of 400-600 μmol/m²·s.

4. The planting method for cereal crops in a plant factory to promote four to five crops per year according to claim 3, wherein the light environment is configured to be changed correspondingly according to the different growth and development stages of different crops, the photoperiod is controlled within the range of 12-18 h/d, and the light intensity is controlled within the range of 400-600 μmol/m²·s.

5. The planting method for cereal crops in a plant factory to promote four to five crops per year according to claim 3, wherein during the seedling cultivation period, the ambient temperature is 23-28° C. during the day and 18-20° C. at night.

6. The planting method for cereal crops in a plant factory to promote four to five crops per year according to claim 3, wherein during the cultivation period, the ambient temperature is 23-28° C. during the day and 19-21° C. at night.

7. The planting method for cereal crops in a plant factory to promote four to five crops per year according to claim 3, wherein the water and fertilizer management method during the cultivation period includes: regularly applying a compound fertilizer, and controlling the moisture in the substrate by watering only when it is dry.
